(19) United States
(12) Patent Application Publication
(10) Pub. No.: US 2024/0001339 A1
(43) Pub. Date: Jan. 4, 2024

(54) DRYING PROCESSES FOR BIO-COMPATIBLE SPME COATINGS

(71) Applicant: SIGMS-ALDRICH CO. LLC, St. Louis, MO (US)

(72) Inventor: Yong Chen, State College, PA (US)

(21) Appl. No.: 18/253,470

(22) PCT Filed: Dec. 2, 2021
(86) PCT No.: PCT/US2021/072709

§ 371 Date: May 18, 2023

Related U.S. Application Data
(60) Provisional application No. 63/121,035, filed on Dec. 3, 2020.
(60) Provisional application No. 63/121,050, filed on Dec. 3, 2020.
(60) Provisional application No. 63/121,071, filed on Dec. 3, 2020.

(51) Int. Cl. B01J 20/32

(52) U.S. Cl. CPC B01J 20/321; B01J 20/3212; B01J 20/3223; B01J 20/3236; B01J 20/327; B01J 20/3289

(57) ABSTRACT

Improved methods for drying for bio-compatible solid phase microextraction (BioSPME) coatings yielding coatings with highly consistent extraction efficiency and biocompatibility. The methods, adapted to flow-through drying systems involve determining relative humidity in and around the drying system, determining a drying temperature range based on the relative humidity, and maintaining the drying temperature within the determined range while drying the coating.

### CROSS-REFERENCE TO RELATED APPLICATIONS

This application claims the benefit of priority of U.S. Provisional Patent Application Nos. 63/121,071 filed Dec. 3, 2020, 63/121,050 filed Dec. 3, 2020, and 63/121,035 filed Dec. 3, 2020, the entirety of each is incorporated herein by reference.

### BACKGROUND

Solid phase microextraction (SPME) is a sample preparation technique that is fast, economical and versatile. SPME involves extraction of analytes onto a small volume of coating on a substrate, such as a fiber, and subsequent desorption of the analytes in gas chromatography injectors or in organic solvents for liquid chromatography separation and detection. The coating on the SPME substrate is the core part of the device. SPME coatings include a polymeric binder and a solid sorbent. For liquid chromatography (LC) applications, it is desirable that SPME coating be bio-compatible to minimize the interference from sample matrices. Some particularly useful biocompatible SPME coatings are composed of functionalized silica, such as C18 (octadecyl functionalized) silica, in polyacrylonitrile (PAN). It is typically coated onto fibers, which are commercially available as SPME LC probe product.

PAN/C18 coatings are prepared by dissolving PAN into a solvent, such as DMF, mixing the solution with C18 silica to form a slurry, coating the PAN/C18 slurry onto substrates, and evaporating the solvent, which involves drying the coating at elevated temperatures. The drying conditions disclosed by Musteata et al. (Anal. Chem. 2007, 79, 6903-6911) were 1.5 min at 180° C., but the control of humidity during the drying process was not specified. Conventional drying methods follow this procedure. However, it has been found that the process can lead to inconsistent results, such as differences in morphology of the coating, efficacy and biocompatibility.

A need exists for new, controlled methods of drying biocompatible SPME coatings that result in consistent morphology, efficacy and biocompatibility.

### SUMMARY

A new method for drying solid-phase microextration (SPME) coatings, specifically bio-compatible SPME coatings that yield a BioSPME device with consistent extraction efficiency and biocompatibility are provided. The method involves determining the relative humidity (percent RH or RH %) measured at 22±2° C. of a drying system, the drying system including a drying gas such as air or nitrogen, applying an appropriate drying temperature range to the drying system based on the relative humidity, introducing the coated device into the flow-through drying system; and maintaining the drying temperature in the drying system in the selected temperature range for a time sufficient to dry the coating. In some embodiments, the drying system is a flow-through drying system.

In a first embodiment, in which the RH % is greater than 60%, the drying temperature is maintained in the range from 110° C. to 160° C.

In a second embodiment, in which the RH % is in the range from 40% to 60%, the drying temperature is maintained in the range from 80° C. to 110° C.

In a third embodiment, in which the RH % is in the range from 15% to 40%, the drying temperature is maintained in the range from 60° C. to 80° C.

In a fourth embodiment, in which the RH % is less than 15%, the drying temperature is maintained in the range from 10° C. to 50° C.

The biocompatible coatings provided herein include a binder selected from polyacrylonitrile (PAN), polyacrylamide, polyethylene glycol (PEG), polypyrrole, derivatized cellulose, polysulfone, polydimethylsiloxane (PDMS), polyacrylate, polytetrafluoroethylene, and polyaniline and a sorbent selected functionalized silica, carbon, polymeric resins and combinations thereof. In some embodiments the sorbent is C18, C8 or mixed-mode functionalized silica. In other embodiments, the sorbent is a resin selected from HLB resins, divinylbenzene resins, styrene resins, and styrene-divinylbenzene copolymer resins.

### BRIEF DESCRIPTION OF THE DRAWINGS

FIG. 1 shows SEM images of PAN/C18 coating dried at 110° C. at different humidity levels. FIG. 1A the coating was dried at 20% RH; FIG. 1B the coating was dried at 39% RH; FIG. 1C the coating was dried at ˜48% RH; and FIG. 1D the coating was dried at approximately 60-70% RH.

FIG. 2 shows SEM images of PAN/C18 coating dried at 22° C. at different humidity levels. FIG. 2A the coating was dried at 39% RH; FIG. 2B the coating was dried at 27% RH; FIG. 2C the coating was dried at 23% RH; FIG. 2D the coating was dried at 16% RH; FIG. 2E the coating was dried at 10% RH, and FIG. 2F the coating was dried at 7% RH.

### DETAILED DESCRIPTION

Conventional drying processes for biocompatible SPME coatings, such as PAN/C18, disclosed by, e.g., Musteata, et al., is the process of exposure of PAN/C18 slurry to elevated temperatures under ambient atmospheric conditions to evaporate solvent. The resulting coatings, however, have been found, unsatisfactorily, to have inconsistent morphology, efficacy and biocompatibility, without a clear reason for these differences.

It has now unexpectedly been found that by controlling the humidity during the drying process, biocompatible SPME coatings with consistent morphology, efficacy and biocompatibility can be produced. Even more surprisingly, the inventor has found that by controlling the humidity level during drying, the drying temperature may be lowered, while still providing consistent morphology, efficacy and biocompatibility.

It is observed in the invention that the morphology of biocompatible SPME coatings, such as PAN/C18, changes with humidity level in the drying step, and only the coatings, dried at specific combination of temperature and humidity, show good efficacy and biocompatibility.

TABLE 1
Preferred drying temperatures based on RH % at 22± ° C.

| Drying temperature (° C.) | Relative humidity (%, 22° C.) |
|---|---|
| 110 | >60 |
| 80-110 | 40-60 |
| 60-80 | 15-40 |
| 10-50 | <15% |

Based on these findings, new methods for drying solid-phase microextration (SPME) coatings, specifically bio-compatible SPME coatings that yield a BioSPME device with consistent extraction efficiency and biocompatibility are provided. The method involves determining the relative humidity (percent RH or RH %) measured at 22±2° C. of the drying system, choosing an appropriate drying temperature range based on the relative humidity, introducing the coated device into the drying system; and maintaining the drying temperature in the drying system in the selected temperature range for a time sufficient to dry the coating. In certain embodiments, the drying system is a flow-through drying system. Such drying systems utilize a drying gas that flows through the system, the drying gas may be air, nitrogen, or other inert gases.

In accordance with the methods provided herein, the temperature of the drying system, i.e., for a flow-through drying system, the temperature of the drying gas, is selected based on the RH % of the drying gas at 22±2° C. In a first embodiment, in which the RH % is greater than 60%, the drying temperature is maintained in the range from 110° C. to 160° C. In a second embodiment, in which the RH % is in the range from 40% to 60%, the drying temperature is maintained in the range from 80° C. to 110° C. In a third embodiment, in which the RH % is in the range from 15% to 40%, the drying temperature is maintained in the range from 60° C. to 80° C.

In a fourth embodiment, in which the RH % is less than 15%, the drying temperature is maintained in the range from 10° C. to 50° C.

The biocompatible coatings provided herein include a binder selected from polyacrylonitrile (PAN), polyacrylamide, polyethylene glycol (PEG), polypyrrole, derivatized cellulose, polysulfone, polydimethylsiloxane (PDMS), polyacrylate, polytetrafluoroethylene (PTFE), and polyaniline and a sorbent selected functionalized silica, carbon, polymeric resins and combinations thereof. In some embodiments the sorbent is C18, C8 or mixed-mode functionalized silica. In other embodiments, the sorbent is a resin selected from HLB resins, divinylbenzene resins, styrene resins, and styrene-divinylbenzene copolymer resins. Various other features are described below.

SPME coatings useful in the methods provided herein include a binder and a sorbent. In some applications, the binder and sorbent are biocompatible. By biocompatible, it is meant that the coating is compatible with biological samples of interest, should not negatively interfere with the adsorptive properties of the SPME coating or otherwise cause interference in sampling or analysis.

Some non-limiting examples of binders useful for SPME include polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline. For some applications, the binder should also be biocompatible. Particularly suitable biocompatible binders include polyacrylonitrile (PAN), polyethylene glycol (PEG), polypyrrole, derivatized cellulose, polysulfone, polyacrylamide, and polyamide. In a preferred embodiment, the binder is a biocompatible binder. In a particularly preferred embodiment, the biocompatible binder is PAN.

Sorbents useful in the SPME devices described herein include microspheres such as functionalized silica spheres, functionalized carbon spheres, polymeric resins, mixed-mode resins, and combinations thereof. Typically, microspheres useful for liquid chromatography, i.e., affinity chromatography, as well as those useful for solid phase extraction (SPE) and solid phase micro extraction (SPME) are preferred for the coatings described herein.

In particular, the sorbents may include functionalized silica microspheres, such as, for example, C18 silica (silica particles derivatized with a hydrophobic phase containing octadecyl), C8 silica (silica particles having a bonded phase containing octyl), RP-amide-silica (silica having a bonded phase containing palmitamidopropyl), or HS-F5-silica (silica with a bonded phase containing pentafluorophenyl-propyl).

Some other non-limiting examples of suitable sorbents include: normal-phase silica, C1 silica, C4 silica, C6 silica, C8 silica, C18 silica, C30 silica, phenyl/silica, cyano/silica, diol/silica, ionic liquid/silica, Titan™ silica (MilliporeSigma), molecular imprinted polymer microparticles, hydrophilic-lipophilic-balanced (HLB) microparticles, particularly those disclosed in copending U.S. patent application Ser. No. 16/640,575 published as US 2020/0197907, Carboxen® 1006 (MilliporeSigma), poly(divinylbenzene), polystyrene, and poly(styrene-co-divinylbenzene). Mixtures of sorbents can also be used in the coatings. The sorbents used in the coatings described herein may be inorganic (e.g., silica), organic (e.g., Carboxen® or divinylbenzene) or inorganic/organic hybrid (e.g., silica and organic polymer). In a preferred embodiment, the sorbent is C18 silica, C8 silica or mixed-mode functionalized silica. In a particularly preferred embodiment, the sorbent is C18 silica.

The sorbent particles, or microspheres, may have diameters in the range from about 10 nm to about 1 mm. In some embodiments, the spherical particles have diameters in the range from about 20 nm to about 125 μm. In certain embodiments, the microspheres have a diameter in the range from about 30 nm to about 85 μm. In some embodiments, the spherical particle has a diameter in the range from about 10 nm to about 10 μm. It is preferable that the spherical particles have a narrow particle size distribution.

In some embodiments, the sorbent particles have a surface area in the range from about 10 m²/g to 1000 m²/g. In some embodiments, the porous spherical particles have a surface area in the range from about 350 m²/g to about 675 m²/g. In some embodiments, the surface area is about 350 m²/g; in other embodiments, the surface area is about 375 m²/g, in other embodiments, the surface area is about 400 m²/g; in other embodiments, the surface area is about 425 m²/g, in other embodiments, the surface area is about 450 m²/g, in other embodiments, the surface area is about 475 m²/g; in other embodiments, the surface area is about 500 m²/g; in other embodiments, the surface area is about 525 m²/g; in other embodiments, the surface area is about 550 m²/g; in other embodiments, the surface area is about 575 m²/g; in other embodiments, the surface area is about 600 m²/g; in other embodiments, the surface area is about 625 m²/g; in other embodiments, the surface area is about 650 m²/g; in still other embodiment, the surface area is about 675 m²/g; and in still other embodiments, the surface area is about 700 m²/g.

Preferably, the sorbent particles used in the devices described herein are porous. In some embodiments, the spherical particles have an average pore diameter in the range from about 50 Å to about 500 Å. In some embodiments, the porosity is in the range from about 100 Å to about 400 Å, in other embodiments, the porosity is in the range from about 75 Å to about 350 Å Moreover, the average pore diameter for the spherical particles used herein may be about 50 Å, about 55 Å, about 60 Å, about 65 Å, about 70 Å, about 75 Å, about 80 Å, about 85 Å, about 90 Å, about 95 Å, about 100 Å, about 105 Å, about 110 Å, about 115 Å, about 120 Å, about 125 Å, about 150 Å, about 160 Å, about 170 Å, about 180 Å, about 190 Å, or about 200 Å.

Coating

To coat the SPME coating on a substrate, a slurry including the sorbent and binder is prepared.

When the particles are silica particles and the biocompatible coating is PAN, the ratio of PAN:silica can be between 1:0.5 and 1:7 (w/w). The preferred ratio of PAN/silica is 1:2 to 1:6 (w/w). The ratio is based on the bare weight of silica and adjusted to the phase loading on the silica particles. The PAN:solvent solution may be between about 5% (1:20) and about 15% (1:6.7) PAN (w/w). Preferably, the PAN:solvent solution may be between about 6% (1:16.7) and 12% (1:8.3) PAN (w/w). More preferably, the PAN:solvent solution may be about 7.5% (1:13.3) PAN (w/w). The solvent may be selected from dimethylformamide (DMF), dimethyl sulfoxide (DMSO), dimethylamine (DMA), chloroacetonitrile, dioxanone, dimethyl phosphite, dimethyl sulfone, γ-butyrolactone, ethylene carbonate, nitric acid, sulfuric acid and mixtures thereof. Preferably, the solvent is DMF.

In preparation for coating, a slurry of sorbent in binder is prepared. The sorbent, binder and a solvent are weighed into a vessel. If necessary, larger pieces or agglomerates of sorbent are broken down, e.g., with a spatula or mixer. The binder is dissolved in the solvent. Sonication and mixing may also be used to ensure a homogeneous distribution of particles in the binder solution. If desired, the slurry may be degassed prior to coating the substrate.

In a dip coating process, the substrate is lowered into the SPME coating slurry then removed and is dried according to the methods provided herein. Alternately, a spray coating process, in which the slurry is sprayed evenly onto the substrate may be used. For suitable substrates, such as fibers, a continuous coating process may be used.

In accordance with the methods provided herein, the coatings are dried in a temperature-controlled environment in which the drying temperature is selected based on the humidity of the drying environment. In one embodiment, a flow-through drying system is used. The relative humidity (percent RH or RH %) of the drying gas measured at or relative to 22±2° C. The drying temperature, selected based on % RH, is maintained in the drying system as the coating is dried. Suitable drying gases include air, nitrogen, or other inert gases.

In a first embodiment, in which the RH % is greater than 60%, the drying temperature is maintained in the range from 110° C. to 160° C. In a second embodiment, in which the RH % is in the range from 40% to 60%, the drying temperature is maintained in the range from 80° C. to 110° C. In a third embodiment, in which the RH % is in the range from 15% to 40%, the drying temperature is maintained in the range from 60° C. to 80° C. In a fourth embodiment, in which the RH % is less than 15%, the drying temperature is maintained in the range from 10° C. to 50° C.

Conversely, the humidity of the drying system could be selected based on desired drying temperature. In most situations, however, the drying temperature is more easily controlled than the humidity level.

The coating thickness of the SPME coating can be varied to achieve desired properties. In various embodiments, the coating thickness can be in the range from about 0.1 μm to about 200 μm. In preferred embodiments, the coating thickness is in the range from about 2 μm to about 50 μm. In other embodiments, the coating thickness may be, for example, about 1 μm, about 2 μm, about 3 μm, about 4 μm, about 5 μm, about 6 μm, about 7 μm, about 8 μm, about 9 μm, about 10 μm, about 15 μm about 20 μm, about 25 μm, about 30 μm, about 35 μm about 40 μm, about 45 μm, about 50 μm, about 55 μm, about 60 μm, about 65 μm, about 70 μm, about 75 μm, about 80 μm, about 90 μm, about 100 μm, about 110 μm, about 120 μm, about 130 μm, about 140 μm, about 150 μm, about 160 μm, about 170 μm, about 180 μm, about 190 μm, or about 200 μm. In some embodiments, the coating thickness is in the range from about 2 μm to about 50 μm, in other embodiments, the coating thickness is in the range from about 2 μm to about 40 μm, in still other embodiments, the coating thickness is in the range from about 5 μm to about 40 μm, in still other embodiments, the coating thickness is in the range from about 5 microns to about 30 microns, in still other embodiments, the coating thickness is in the range from about the coating thickness is in the range from about 10 microns to about 100 microns. In a preferred embodiment, the coating thickness is in the range from about 10 μm to about 50 μm. The coating thickness can be varied, for example, by performing the coating step multiple times. Thinner coatings, for example, may be used when sample sizes are very small or when fast equilibrium extraction is required, however, a thinner coating may limit the amount of analyte that may be extracted. For multipin devices it is preferred that the coating thickness is consistent on all pins.

In some embodiments, the SPME coating is applied directly to the substrate without pretreatment. In other embodiments, the substrate may be pre-treated before the SPME coating is applied. When the substrate is plastic, the plastic substrate may be pretreated to roughen the surface to improve adhesion of the SPME coating to the surface. Some conventional methods to roughen plastic surfaces include, for example, mechanical methods such as sandblasting, tumbling, and abrading with power tools; physical methods such as flame, corona discharge, plasma; or chemical methods such as acid etching, anodization to enhance adhesion of the SPME coating to the substrate. In a preferred embodiment, the plastic substrate may be coated with a pre-coating to enhance adherence of the SPME coating to the substrate. Preferred pre-coatings may include X18 (Master Bond, Inc.), optionally including particulate, such as silica, carbon or polymeric resins, or PAN. When a pre-coating is used, the substrate is coated with the pre-coating, allowed to dry, then coated with the SPME coating, then immersed in water for a time sufficient to form the SPME coating film. Such pre-coatings are described in greater detail in applicant Sigma-Aldrich Co. LLC's copending international application entitled “Pre-Coatings for BioSPME Devices,” filed Dec. 2, 2021.

The methods described herein are useful for drying coatings on any device useful for SPME, including, for example, fibers, blades, tubes, screens or mesh, columns, and pins. As used herein, the term “pin” includes a thin piece of metal or plastic with a tip at one end. Such pins may be cylindrical, rod-like, conical, frustoconical, pyramidal, frustopyramidal, rectangular, square, and so forth. The pins described herein preferably have a solid, closed surface. When the pins are referred to as “solid pins” or as “wherein the pins are solid” means that the surface of the pins is solid. Solid pins, as defined herein, may be differentiated from a design having an opening in the tip, as may be used as a housing for holding an SPE or SPME fiber, wherein the typically metal fiber would be the substrate coated with the SPE or SPME coating. The surface of the pins is coated with the SPME coating. Since only the coated outer surface of the pins comes into contact with a sample, it is not critical whether the inner surface is solid or hollow as neither the coating, nor the sample, contact the inner surface. The tip, or point, of the pin may flat, rounded, or may come to a point. In some embodiments, the SPME device may include a single pin, while in other embodiments, the device may include a plurality of pins. A particularly preferred pin device is described in copending International Publication No. WO 2019/036414, the entirety of which is incorporated herein by reference.

Preferably, the pins have a diameter in the range from about 0.2 mm to about 5 mm. In preferred embodiments, the diameter of the pins is in the range from about 0.5 mm to about 2 mm. In a particularly preferred embodiment, the pins have a diameter of about 1 mm. The length of the pin can be varied, as for example, to accommodate various sample volumes and well depths. The length of the pins is preferably in the range from about 0.2 mm to about 5 cm. In some embodiments, the length may be from about 0.5 mm to about 2.5 cm. In other embodiments, the length may be from about 1 mm to about 1 cm.

The pins may be made of any suitable material, including, for example, plastic, metal, glass, ceramics, and so forth. In preferred embodiment, the pins are made of plastic. Some non-limited examples of suitable plastics for SPME substrates, such as pins include, but are not limited to polyolefins, polyamides, polycarbonate, polyester, polyurethanes, polyvinyl chloride, polytetrafluoroethylene (PTFE), polyetheretherketone (PEEK), polysulfone, and polyterephthalate substrates. In some preferred embodiments, the plastic pins are polypropylene or polyethylene.

The coatings described herein, the pre-coating and the SPME coating, are applied to the end of the pin that will contact the sample of interest. In some embodiments, approximately half of the length of the pin is coated with the pre-coating and the SPME coating. In other embodiments, approximately one quarter of the length of the pin is coated with the pre-coating and the SPME coating. In various embodiments, the pre-coating and SPME coating may cover a certain portion of the length of the pin or pins, for example, 1/10, ⅕, ¼, ⅓, or ½ of the length of the pin or pins. In other embodiments, the coating may be measured from the tip of the pin, that is, the end of the pin that will contact the sample. In some embodiments, the precoating and coating may cover 1 mm of the pin, in other embodiments, the precoating and coating may cover 1.5 mm, while in other embodiments, the precoating and coating may cover 2 mm of the pin. In an embodiment for a 1 cm pin, the precoating and coating may cover 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm or 5 mm from the end of the pin. In other embodiments, other suitable coatings coverage may readily be determined based on the length, shape and diameter of the pin.

When the device includes more than one pin, e.g., 4 pins, 8 pins, 12 pins, 16 pins, 24 pins, 48 pins, 96 pins, 384 pins or 1536 pins, it is preferred that the coatings cover a similar portion of each pin. In one embodiment, the pins of a multipin device are coated simultaneously using a dip coating process. In such a process, the plastic multipin device is first dipped into the pre-coating, removed, and allowed to dry, and then is dipped in the SPME coating, removed, and dried using the methods provided herein. Only the portion of the pins to be coated are contacted with the coating preparations or slurries. Such coating methods can ensure consistent coating on all pins in the device. Alternately, other coating methods, such as spray coating or continuous coating, may be used. In both single pin and multipin embodiments, dip coating is the most preferred method of applying the pre-coating and SPME coating layers to the plastic substrate/pins.

SPME coatings prepared using the methods described herein were observed visually, tested for ruggedness and adhesion, and evaluated for extraction efficiency and protein binding. Exemplary methods for these evaluations are outlined below.

The dried coatings are observed visually using an optical microscope and/or SEM. The ruggedness and adhesion of coatings were tested by (a) by finger rub on the cured coating, and (b) by blue tape adhesion test. The blue tape adhesion test is performed as follows: blue painters' tape (medium adhesion) is applied to the coated, cured SPME device and allowed to stay in place for 90 seconds, the tape is then removed at a 180-degree angle relative to the device. Adhesion is observed visually using a microscope.

To test extraction efficiency, 96-pin SPME devices were coated with PAN/C18 SPME coatings and dried using the method described herein. The SPME devices were tested using the following extraction procedure.

Conditioning: 20 min in 800 μL of Isopropanol in Nunc 1 mL 96-well plate at ˜1200 rpm

Wash: 10 sec in 800 μL water in Nunc 1 mL 96-well plate at ˜1200 rpm.

Extraction: 30 min in 800 μL of buffer in Nunc 1 mL 96-well plate at ˜1200 rpm on shaker. Prepared spike at 5000 ng/mL with carbamazepine in PBS Buffer pH=7.48. Percent organic content was 0.5%. Contents at room temp.

Wash: 10 sec in 800 μL water in Nunc 1 mL 96-well plate at ˜1200 rpm.

Desorption: 20 min in 400 μL 80:20 Methanol:Water with Axygen 600 μL conical 96-well plate at ˜1200 rpm.

Robotic system: Apricot

Pin tools were analyzed on an HPLC with UV detection using the parameters in Table 2.

TABLE 2
HPLC Parameters for measuring extraction efficiency.

| Column: | Ascentis Express C18 column (5 cm × 2.1 mm, | |
|---|---|---|
| | 2.7 μm) | |
| Mobile phase A: | Water | |
| Mobile phase B: | Acetonitrile | |
| Column Temp: | 40° C. | |
| Inj. Vol.: | 5 μL | |
| Wavelength: | 285 nm | |
| Flow rate: | 0.4 mL/min. | |
| | Time | % B |
| Isocratic: | 0 | 30 |
| | 1.5 | 30 |

| | |
|---|---|
| Analyte: | Carbamazepine, pKa 13.9, Log p 2.45, MW 236 g/mol |

Protein Binding Extraction Procedure. Protein binding was testing using the following extraction procedure.

Conditioning: 20 min in 800 μL of Isopropanol in Nunc 1 mL 96-well plate static.
Wash: 10 sec in 800 μL water in Nunc 1 mL 96-well plate static.
Extraction: 30 min in 800 μL of 100 ng/mL in buffer or plasma/serum in Nunc 1 mL conical 96-well plate at ˜1200 rpm with adapter. Temp set to 37° C.
Wash: 60 sec in 800 μL water in Nunc 1 mL 96-well plate static.
Desorption: 20 min in 400 μL 80:20 Methanol:Water with Axygen 600 μL conical 96-well plate static.
Robotic system: Hamilton
Protein Binding LC/MS Method was done on an Agilent 1290/AB Sciex 650 Q Trap using the conditions in Table 3.

TABLE 3
LC/MS Conditions for Protein Binding Assay.

| Column: | Ascentis Express Biphenyl column (10 cm × 2.1 mm, 2.7 μm) | | |
|---|---|---|---|
| Mobile | 5 mM ammonium formate with 0.1% formic acid in 95:5, | | |
| phase | water:acetonitrile | | |
| A: | | | |
| Mobile | 5 mM ammonium formate with 0.1% formic acid in 5:95, | | |
| phase | water:acetonitrile | | |
| B: | | | |
| Column | 40° C. | | |
| Temp: | | | |
| Inj. Vol. | 2 μL | | |
| Flow | 0.4 mL/min | | |
| Rate: | | | |
| | | Time | % B |
| Gradient: | | 0.0 | 10 |
| | | 0.5 | 10 |
| | | 3.0 | 90 |
| | | 4.0 | 90 |
| | | 4.1 | 10 |
| | | 6.0 | 10 |
| Analyte: | Carbamazepine, pKa 13.9, Log p 2.45, MW 236 g/mol | | |
| | | Carbamazepine | Carbamazepine-D10 |
| | Precursor | 237.09 | 247.1 |
| | Product | 194.0 | 204.1 |
| | Dwell (msec) | 75 | |
| | DP (volts) | 35 | |
| | EP (volts) | 7 | |
| | CE (volts) | 29 | |
| | Polarity | + | |

Coatings prepared using the methods described herein were found to have good extraction efficiencies, using the analysis method described above, more consistently than coatings prepared using conventional methods. While the evaluation methods outlined above were performed using a 96-pin device, these exemplary methods are not limited to such devices but may be used for other SPME devices as well.

### Examples

Example 1. Preparation of the BioSPME coating slurry of C18 in PAN and coating of SPME device. 40.0 g of PAN was weighed into 500.0 g of DMF. The PAN was broken into small pieces using a spatula. The mixture was incubated at 85° C. until dissolved.

132 g of C18 was weighed into the PAN/DMF solution. The mixture was mixed well with a spatula, then the resulting slurry was roller mixed for 60 min. The slurry was then sonicated the mixture for 20 min, and then homogenized for 45 min. The process was then repeated. The resulting slurry was degassed and then mixed until ready to coat.

Example 2. Devices were coated using the SPME slurry of Example 1 and dried at a constant temperature of 110° C. at 20% relative humidity (RH), 39% RH, approximately 48% RH, and between about 60-70% RH. The extraction efficiencies are shown in Table 4.

TABLE 4
Extraction efficiencies of coatings
dried at 110° C. at varying RH %.

| Sample | 01082020-2 | 02042020-22 | 02042020-39 | 08302019 |
|---|---|---|---|---|
| RH % | 20 | 39 | ~48 | ~60-70 |
| Extraction | ~0.3 | ~0.6-0.7 | ~0.9 | ~1.1 |
| Efficiency | | | | |

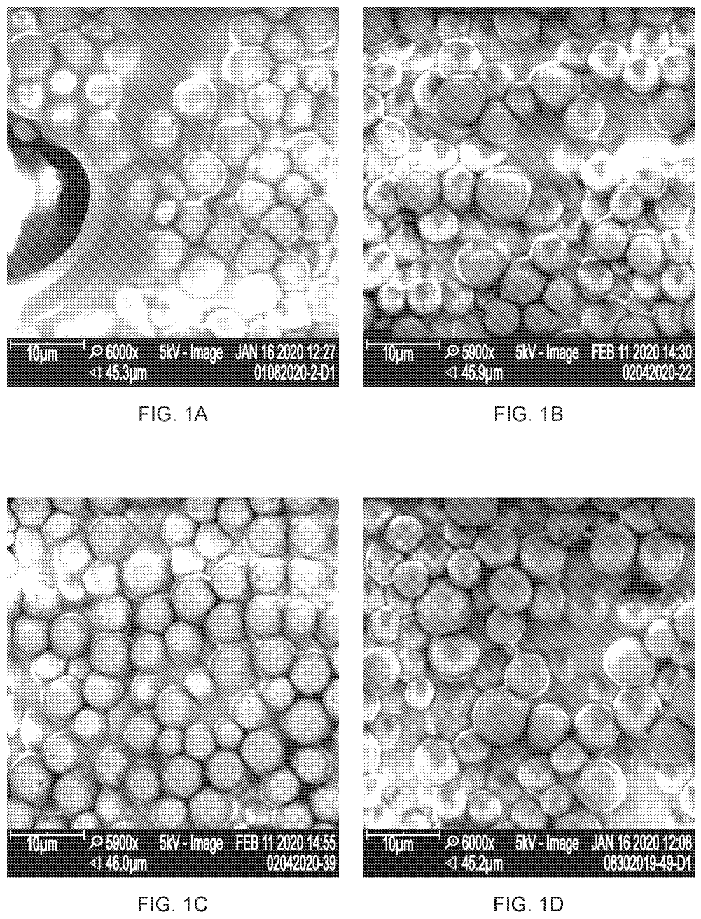

FIG. 1 shows the SEM images of PAN/C18 coating dried at 110° C. at different humidity levels. When the relative humidity changed from 20% to 70%, the extraction efficiency of the coating changed from 0.3 to 1.1 as shown in Table 4.

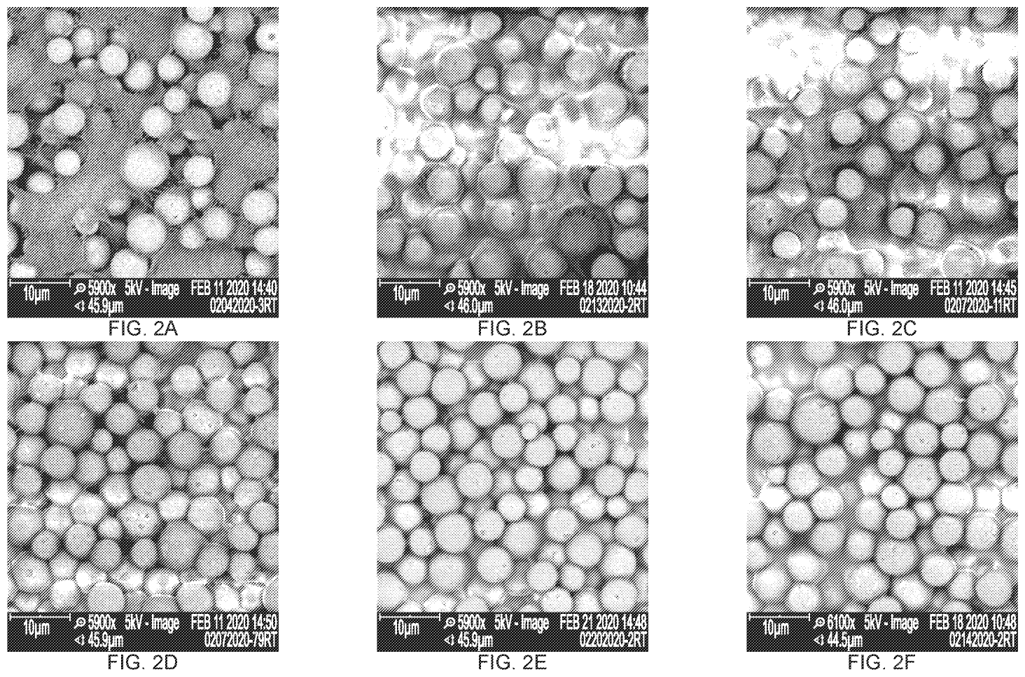

Example 3. To further investigate the effect of humidity level on drying, SPME devices were coated with the coating of Example 1. The drying temperature was held constant at 22° C. and the percent relative humidity was varied from 39% to 7%. The humidity levels, extraction efficiency and protein binding are shown in Table 5, and SEM images are shown in FIG. 2.

TABLE 5
Extraction Efficiencies and Protein Binding of PAN/C18
coating dried at 22° C. at different humidity levels.

| | 02042020- | 02132020- | 02072020- | 02072020- | 02202020- | 02142020- |
|---|---|---|---|---|---|---|
| Sample | 3RT | 2RT | 11R | 79RT | 2RT | 2RT |
| RH % | 39 | 27 | 23 | 16 | 10 | 7 |
| Extraction | ~2.4 | ~2.4 | ~2.2 | ~1.5 | ~1.3 | ~1.1 |
| Efficiency | | | | | | |
| Protein | ~90% | | | | 82% | |
| Binding | | | | | | |

When the PAN/C18 coating was dried at 22° C. under different humidity levels, the morphology of the coating changed dramatically, as shown in FIG. 2. Additionally, the extraction efficiency of the coating decreased with the decrease of the relative humidity. In addition, only the coating dried at low humidity levels (<15 RH % at 22° C.) showed good biocompatibility. When the coating was dried at RH % larger than 15% at 22° C., the coating was readily fouled by plasma matrix, and produced inaccurate protein binding values. The protein binding for the device 02042020-3RT dried at 22° C. and 39% RH was significantly higher that the reference protein binding (70-80%). While the protein binding for the device 02202020-2RT dried at 22° C. and 10% RH with coatings prepared by the methods described herein agrees well with the reference protein binding.

The PAN/C18 coating, dried at high temperatures, such as 110° C., showed good biocompatibility. However, to ensure the efficacy of the coating, the humidity at the drying step must be high (>60%). The PAN/C18 coating, dried at low temperatures, such as 22° C., showed good efficacy. However, to ensure the biocompatibility of the coating, the humidity at the drying step must be low (<15%). The biocompatibility and efficacy of PAN/C18 coating changed with both drying temperature and humidity. To ensure the biocompatibility and efficacy of PAN/C18 coating, drying temperature and humidity must be controlled. Preferred drying temperatures based on RH % are listed in Table 1.

Example 4. A PAN/C18 slurry was prepared as in Example 1. 96-pin devices were pre-treated as disclosed in applicant Sigma-Aldrich Co. LLC's copending international application entitled “Pre-Coatings for BioSPME Devices” filed Dec. 2, 2021. The pre-treated devices were dip coated with the PAN/C18 slurry. Conditions for dip coating were: up: 0.25 mm/s, down: 1 mm/s, dwell time: 3 s, dip: 4.95 mm, rake rest: 15 s.

Example 5. Two 96-pin devices were coated using the slurry of Example 4. One was dried at 60° C., 34% RH; the second was dried at 80° C., 35% RH. Protein binding was measure using the method outlined above, for carbamazepine. The reference protein binding for carbamazepine is 70-80% for conventional SPME devices. The results are summarized in Table 6, below.

TABLE 6
Protein binding for 2 pin tools.

| | Buffer | Buffer | Plasma | Plasma | | |
|---|---|---|---|---|---|---|
| | avg | rsd | avg | rsd | Protein | Drying |
| Device | (ng/mL) | (%) | (ng/mL) | (%) | Binding | Conditions |
| Ex5-1 | 27.7 | 1.0 | 5.0 | 5.5 | 81.9% | 60° C. |
| | | | | | | 34% RH |
| Ex5-2 | 25.2 | 2.1 | 5.4 | 3.2 | 78.5% | 80° C. |
| | | | | | | 35% RH |

The protein binding for the two devices with coatings prepared by the methods described herein agrees well with the reference protein binding.

The invention claimed is:

1. A method for drying a coating suitable for bio-compatible solid phase microextraction (BioSPME) in a flow-through drying system, the method comprising
determining relative humidity at 22±2° C. (RH %) of the drying system,
selecting an appropriate drying temperature range for the drying system based on the RH % of the drying system,
adjusting the temperature of the drying system within the selected temperature range;
introducing a device comprising a BioSPME coating into the drying system; and
maintaining the temperature of the drying system within the selected temperature range for a time sufficient to dry the coating.

2. The method of claim 1 wherein when the RH % is greater than 60%, the drying temperature is maintained in the range from 110° C. to 160° C.

3. The method of claim 1 wherein when the RH is in the range from 40% to 60%, the drying temperature is maintained in the range from 80° C. to 110° C.

4. The method of claim 1 wherein when the RH is in the range from 15% to 40%, the drying temperature is maintained in the range from 60° C. to 80° C.

5. The method of claim 1 wherein when the RH is less than 15%, the drying temperature is maintained in the range from 10° C. to 50° C.

6. The method of claim 1 wherein the drying system comprises a drying gas, and the drying gas is selected from the group consisting of air, nitrogen, and other inert gases.

7. The method of claim 1 wherein the BioSPME coating comprises a binder and a sorbent.

8. The method of claim 7 wherein
the binder is selected from the group consisting of binder is selected from the group consisting of polyacrylonitrile (PAN), polyacrylamide, polyethylene glycol (PEG), polypyrrole, derivatized cellulose and polysulfone, polydimethylsiloxane, polyacrylate, polytetrafluoroethylene and polyaniline; and
the sorbent is selected from the group consisting of functionalized silica, carbon, polymeric resins and combinations thereof.

9. The method of claim 8 wherein the binder comprises PAN and the sorbent comprises C18, C8 or mixed-mode functionalized silica.

10. The method of claim 8 wherein the sorbent is a polymeric resin selected from the group consisting of HLB resins, divinylbenzene resins, styrene resins, divinylbenzene-co-styrene resins and combinations thereof.

11. A device for solid phase microextraction made by the method of claim 1.
